(19) United States
(12) Patent Application Publication
(10) Pub. No.: US 2006/0243161 A1
(43) Pub. Date: Nov. 2, 2006

(54) Plasticizer compositions for nitrocellulose based resins

(75) Inventors: Wanderson Bueno De Almeida, San Jose dos Campos (BR); Katia Braga, São José dos Campos (BR); Henrique Jorge Sousa Sales, São José dos Campos (BR)

Correspondence Address: COGNIS CORPORATION;PATENT DEPARTMENT, 300 BROOKSIDE AVENUE, AMBLER, PA, 19002, US

(73) Assignee: Cognis Brazil LTDA, Sao Paulo (BR)

(21) Appl. No.: 10/536,544

(22) PCT Filed: Dec. 6, 2002
(86) PCT No.: PCT/BR02/00176

§ 371 Date: Jun. 1, 2006

(51) Int. Cl. C09D 101/18; C08L 91/00

(52) U.S. Cl. 106/169.41; 106/169.43; 106/243; 106/287.24; 106/316

(57) ABSTRACT

The invention is a plasticizer for nitrocellulose based resins, a method for plasticizing a nitrocellulose based resin and a nitrocellulose based paint containing the plasticizer. The plasticizer contains a mixture of (i) at least one isobutanol ester of a fatty acid with 8 to 24 carbon atoms. The acids can be saturated or unsaturated, linear or branched, and contain at least one epoxy group per molecule and (ii) at least one methyl ester of a fatty acid with 16 to 18 carbon atoms which acids can be saturated or olefinically unsaturated, linear or branched.

### FIELD OF THE INVENTION

The invention relates to plasticizer compositions for nitrocellulose based resins.

### DESCRIPTION OF THE RELATED ART

Paints or pigment concentrates based on nitrocellulose based resins are widely used for graphic arts and several industrial coatings. The most important property achieved with systems based on nitrocellulose is short drying time.

It is well known that nitrocellulose based resins are not flexible and must be plasticized before applying. Besides that application systems like paints and pigment concentrates must show a viscosity which is low enough so that the system is pumpable. Phthalic ester type plasticizers are commonly used in these systems, but they have been criticized because of their environmentally harmful action.

### DETAILED DESCRIPTION OF THE INVENTION

It was an object of the present invention to provide plasticizer compositions for nitrocellulose based resins, which overcome the difficulties and disadvantages of the prior art. It was a further object of the invention that paint formulations comprising those plasticizer compositions show a reduced viscosity compared with formulations based on phthalic acid esters like di-octyl phthalate (DOP). Within the present application the term “nitrocellulose based resins” means resins which comprise nitrocellulose. As it is known to the artisan nitrocellulose is nitrated cellulose.

According to the invention this is achieved by plasticizer compositions for nitrocellulose based resins comprising (i) esters of fatty acids with 8 to 24 carbon atoms and isobutanol with the proviso that the fatty acids can be saturated or olefinically unsaturated, linear or branched and contain at least one epoxy group per molecule and (ii) one or more methyl esters of fatty acids with 16 to 18 carbon atoms with the proviso that these fatty acids can be saturated or olefinically unsaturated, linear or branched.

Preferably these plasticizer compositions are free of phthalic ester type plasticizers and especially free of dioctylphthalate.

In one embodiment the plasticizer compositions of the invention contain compounds (i) and (ii) in an amount that the weight ratio of compounds (i) and (ii) is within the range 90:10 and 50:50 and especially within the range 65:35 and 55:45. In another embodiment these plasticizer compositions contain exclusively compounds (i) and (ii).

The invention also relates to the use of compositions comprising (i) esters of fatty acids with 8 to 24 carbon atoms and isobutanol with the proviso that the fatty acids can be saturated or olefinically unsaturated, linear or branched and contain at least one epoxy group per molecule and (ii) one or more methyl esters of fatty acids with 16 to 18 carbon atoms with the proviso that these fatty acids can be saturated or olefinically unsaturated, linear or branched as plasticizers for nitrocellulose based resins. As stated above the compositions are preferably free of phthalic ester type plasticizers.

As also stated above the compositions preferably contain compounds (i) and (ii) in an amount that the weight ratio of compounds (i) and (ii) is within the range 90:10 and 50:50 and especially within the range 65:35 and 55:45. Those plasticizer compositions which exclusively contain compounds (i) and (ii) are preferred.

The invention also relates to nitrocellulose based paints comprising (a) 100 parts by weight of at least one nitrocellulose resin, (b) 100 to 200 parts by weight of an alkyd resin and (c) 0,1 to 30 parts of a plasticizer composition comprising (i) esters of fatty acids with 8 to 24 carbon atoms and isobutanol with the proviso that the fatty acids can be saturated or olefinically unsaturated, linear or branched and contain at least one epoxy group per molecule and (ii) one or more methyl esters of fatty acids with 16 to 18 carbon atoms with the proviso that these fatty acids can be saturated or olefinically unsaturated, linear or branched. Those nitrocellulose based paints which are free of phthalic ester type plasticizers are preferred.

As already stated above the plasticizer compositions contain compounds (i) and (ii) in an amount that the weight ratio of compounds (i) and (ii) is within the range 90:10 and 50:50 and especially within the range 65:35 and 55:45. Those plasticizer compositions which contain exclusively compounds (i) and (ii) are preferred.

The term “alkyd resins” is known to the artisan. All types of alkyd resins which are known to the artisan and especially all kinds of alkyd resins which are commercially available can be used within the context of the present invention.

All types of nitrocellulose based resins which are known to the artisan can be used within the context of the present invention, especially all kinds of nitrocellulose based resins which are commercially available.

### EXAMPLES

IES=Isobutyl epoxy stearate.

IFAME=Mixture of methyl esters of fatty acids. The distribution of the fatty acid individuals in these methyl esters was (% means mole-%): straight shain C12=0.3%, branched chain C14=0.4%, straight chain C14=1.0%, branched chain C16=3.7% , straight chain C16=4.9%, branched chain C18=61.4%, straight chain C18=4.6%, cyclic C18=17.5%, straight chain C20=0.1%, aromatic C18=6.1%.

NC ½=Cellulose nitrate (Nitrocellulose ½ commercially available from Nitro Quimica).

Resanol 15-075=pure coconut alkyd resin with 60% solid content and 40% xylene as solvent (“Resanol 15-075” commercially available from RESANA Quimica, Brasil); % means weight percent.

Mix of solvents=Mixture of 20% ethyl acetate, 17.5% butyl acetate, 12.5% butanol, 10% ethanol and 40% xylene (% means volume percent).

DOP=dioctyl phthalate

### Example 1

(Nitrocellulose based paint)

| The following compounds were mixed together in a vessel: | | |
|---|---|---|
| Mix of Solvents | 278 | g |
| Resanol 15-075 | 200 | g |
| IES | 15 | g |
| IFAME | 10 | g |
| Under stirring it was added under nitrogen: | | |
| NC ½ | 100 | g |

The resulting mixture (paint) was then homogenized and the viscosity of the system was measured. It was 3700 mPas. The value of the viscosity is lower compared to the formulation of comparative example 1 which is based on dioctyl phthalate as plasticizer.

### Comparative Example 1

(Nitrocellulose based paint)

| The following compounds were mixed together in a vessel: | | |
|---|---|---|
| Mix of Solvents | 278 | g |
| Resanol 15-075 | 200 | g |
| DOP | 25 | g |
| Under stirring it was added under nitrogen: | | |
| NC ½ | 100 | g |

The resulting mixture (paint) was then homogenized and the viscosity of the system was measured. It was 4200 mPas.

1-11. (canceled)

12. A plasticizer composition for nitrocellulose based resins comprising: (i) at least one isobutanol ester of a fatty acid with 8 to 24 carbon atoms, wherein, the fatty acid can be saturated or olefinically unsaturated, linear or branched and contains at least one epoxy group per molecule and (ii) at least one methyl ester of a fatty acid with 16 to 18 carbon atoms, wherein, the fatty acid can be saturated or olefinically unsaturated, linear or branched.

13. The composition according to claim 12, wherein, the composition is free of phthalic ester plasticizers.

14. The composition according to claim 12, wherein, the weight ratio of (i) to (ii) is within the range 65:35 to 55:45.

15. The composition according to claim 12, wherein, the composition consists of (i) and (ii) as plasticizing agents.

16. A method of plasticizing a nitrocellulose containing resin composition which comprises: incorporating into the resin composition a plasticizing amount of a plasticizer composition comprising: (i) at least one ester of a fatty acid with 8 to 24 carbon atoms, wherein, the fatty acid can be saturated or olefinically unsaturated, linear or branched and contains at least one epoxy group per molecule and (ii) at least one methyl ester of a fatty acid with 16 to 18 carbon atoms, wherein, the fatty acid can be saturated or olefinically unsaturated, linear or branched.

17. The method according to claim 16, wherein, the composition is free of phthalic ester plasticizers.

18. The method according to claim 16, wherein, the weight ratio of (i) to (ii) is from 65:35 to 55:45.

19. The method according to claim 16, wherein, the plasticizer composition consists of (i) and (ii) as plasticizing agents.

20. A nitrocellulose based paint comprising (a) 100 parts by weight of at least one nitrocellulose resin, (b) 100 to 200 parts by weight of an alkyd resin and (c) 0.1 to 30 parts of a plasticizer composition comprising (i) at least one isobutanol ester of a fatty acid with 8 to 24 carbon atoms, wherein, the fatty acid can be saturated or olefinically unsaturated, linear or branched and contains at least one epoxy group per molecule and (ii) at least one methyl ester of a fatty acid with 16 to 18 carbon atoms, wherein, the fatty acid can be saturated or olefinically unsaturated, linear or branched.

21. The nitrocellulose based paint according to claim 20, wherein, the paint is free of phthalic ester plasticizers.

22. The nitrocellulose based paint according to claim 20, wherein, the plasticizer composition consists of (i) and (ii) as plasticizing agents.

23. The composition according to claim 13, wherein, the weight ratio of (i) to (ii) is within the range 65:35 to 55:45.

24. The method of claim 17, wherein, the weight ratio of (i) to (ii) is from 65:35 to 55:45.
